(19) United States
(12) Patent Application Publication
(10) Pub. No.: US 2005/0018395 A1
(43) Pub. Date: Jan. 27, 2005

(54) Cradle having beam projector for portable terminal

(75) Inventors: Seung-Min Park, Seoul (KR); Chang-Soo Lee, Incheon (KR); Sung-Kwon Kim, Gwangmyeong-si (KR); Jun-Sang Park, Anyang-si (KR); Jun Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-Do (KR)

(21) Appl. No.: 10/812,280

(22) Filed: Mar. 29, 2004

(30) Foreign Application Priority Data
Jul. 23, 2003 (KR) 50657/2003

(51) Int. Cl. G06K 7/10

(52) U.S. Cl. 361/683

(57) ABSTRACT

Disclosed is a cradle having a beam projector for a portable terminal. The cradle includes a desk-top housing, a cradle housing having an upper portion with a first opening, a rear portion with a second opening, and a front portion and both lateral portions which form a closed wall, the cradle housing having a recess defined by the closed wall in order to cradle the portable terminal, the cradle housing being rotatably mounted about an hinge axis on the desk-top housing so that the rear portion pops in and out the desk-top housing, and an optical alignment system mounted at a predetermined position of the cradle housing and emitting a beam in a predetermined direction.

### PRIORITY

This application claims priority to an application entitled “Cradle Having Beam Projector for Portable Terminal” filed in the Korean Industrial Property Office on Jul. 23, 2003, and assigned Serial No. 2003-50657, the contents of which are incorporated herein by reference.

### BACKGROUND OF THE INVENTION

1. Field of the Invention

The present invention relates generally to a portable terminal, and more particularly to a cradle for a portable terminal, which has a charging function as well as a beam projector.

2. Description of the Related Art

In general, “portable terminals” are electronic devices which a user can carry with him/her to perform wireless communication with a desired partner. In consideration of portability, design of such a portable terminal has tended not only toward compactness, slimness and lightness, but also toward multimedia capable of pursuing more various functions. The portable terminals may be used for more functions and purposes other than compactness and lightness, and they may be modified to be suitable for environments of various multimedia or internets. Additionally, such portable terminals may be used by men and women, young and old, anywhere in the world.

Conventional portable terminals are classified into various types based on their appearances, such as a bar-type, a flip-type or a folder-type. The bar-type portable terminal has a single housing shaped like a bar. The flip-type portable terminal has a flip which is privotably mounted to a bar-shaped housing by the hinge unit. The folder-type portable terminal has a folder coupled to a single bar-shaped housing by a hinge unit, thus the folder can be rotated in order to be folded to or unfolded from the housing.

Furthermore, the portable terminal may be classified as a necklace-type or a wrist-type based on a position at or a way in which a user puts it on. The neck wearable type portable terminal is one which a user wears around the neck using a string, while the wrist wearable type portable terminal is one which is worn around the wrist of the user.

Additionally, such portable terminals may be classified into a rotation-type or a sliding-type according to ways of opening and closing the terminals. In the rotation-type communication device, two housings are coupled to each other in a manner that one housing rotates to opened or closed relative to the other while facing each other. In the sliding-type communication device, two housings are coupled to each other in a manner that one housing slides to be opened or closed relative to the other. The above described various types of portable terminals are known by those skilled in the art.

Furthermore, each of the conventional portable terminals described above has been designed to enable a voice communication as well as a high-speed data communication. As consumer demands have been increased, various services have been provided using wireless communication technology for transceiving data at a high speed.

It is a present tendency that a camera lens is mounted to the portable terminal, and that it is possible to transmit image signals and the like.

Commonly, present portable terminals are provided with an embedded or external camera lens module. Therefore, it is possible to perform an image communication with a desired partner or to photograph a desired subject.

Generally, the portable terminals use a cradle in order to charge a battery of the portable terminal or to restrain the portable terminal from moving arbitrarily within a motor vehicle. The cradle has been typically used to cradle the portable terminal for the purpose of charging the battery of the portable terminal.

Furthermore, the portable terminals are equipped with more additional functions, thus tending to diversify. In response to this tendency, an attempt has been made to provide the cradle for the portable terminal with other additional functions in order to provide convenience to the user of the portable terminal.

However, the conventional cradle for the portable terminal has a drawback in that it does not yet perform additional functions other than a cradling function.

### SUMMARY OF THE INVENTION

Accordingly, the present invention has been made to solve the above-mentioned problems occurring in the prior art, and an object of the present invention is to provide a cradle for a portable terminal, which has a beam projector mounted on a cradle housing.

It is another object of the present invention to provide the cradle for the portable terminal, which has the beam projector and the cradle housing enabling an adjustment of a rotating angle, thereby enabling adjustment of an angle at which a beam is emitted from the beam projector.

In order to accomplish these objects, there is provided the cradle for the portable terminal including: a desk-top housing; the cradle housing having an upper portion with a first opening, a rear portion with a second opening, and a front portion and both lateral portions which form a closed wall, the cradle housing having a recess defined by the closed wall in order to cradle the portable terminal, the cradle housing being rotatably mounted about an hinge axis on the desk-top housing, thus the rear portion pops in and out the desk-top housing; and an optical alignment system mounted at a predetermined position of the cradle housing and emitting a beam in a predetermined direction.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a cradle according to a preferred embodiment of the present invention;

FIG. 2 is a side view of the cradle shown in FIG. 1;

FIG. 3 is a perspective view illustrating a beam projector mounted on the cradle according to a preferred embodiment of the present invention;

FIG. 4 is a side view of the beam projector shown in FIG. 3, illustrating a direction of a beam emitted from the beam projector as an arrow;

FIG. 5 is a top plan view of the cradle shown in FIG. 1;

FIG. 6 is a side view of the beam projector shown in FIG. 4, illustrating that an upper portion of the cradle housing is cut away; and

FIG. 7 is a perspective view illustrating that a portable terminal is cradled in the cradle according to a preferred embodiment of the present invention.

### DETAILED DESCRIPTION OF THE PREFERRED EMBODIMENT

Hereinafter, preferred embodiments of the present invention will be described in detail with reference to the accompanying drawings. In the drawings, the same or similar elements are denoted by the same reference numerals even though they are depicted in different drawings. In the following description of the present invention, a detailed description of known functions and configurations incorporated herein will be omitted for clarity where they are well-known in the art.

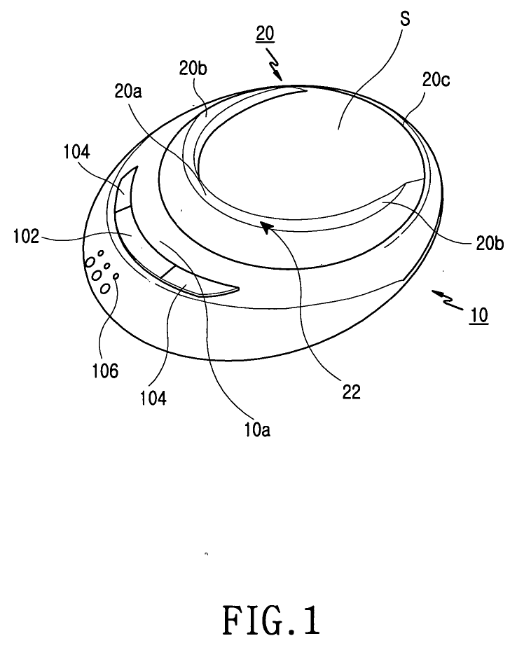

As illustrated in FIGS. 1 to 4, a cradle for a portable terminal according to the preferred embodiment of the present invention is a desk-top type. The cradle according to the preferred embodiment of the present invention functions as a charger. The cradle is electrically connected with the portable terminal wirelessly in order to charge the portable terminal. Thus, there is no connection terminal, which is used to charge the portable terminal.

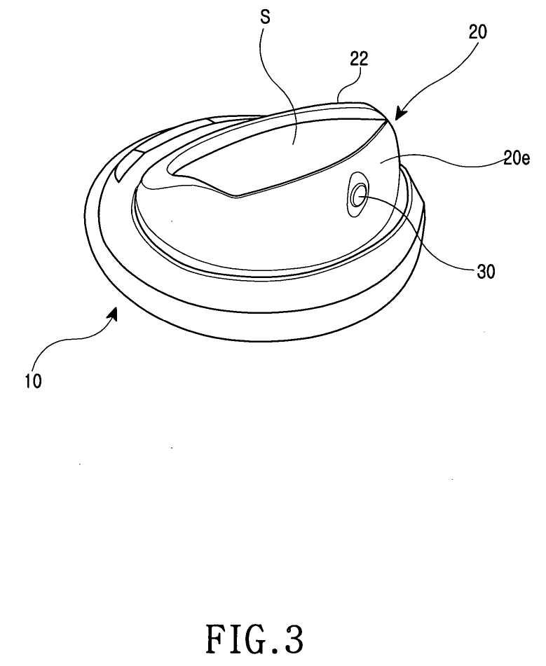

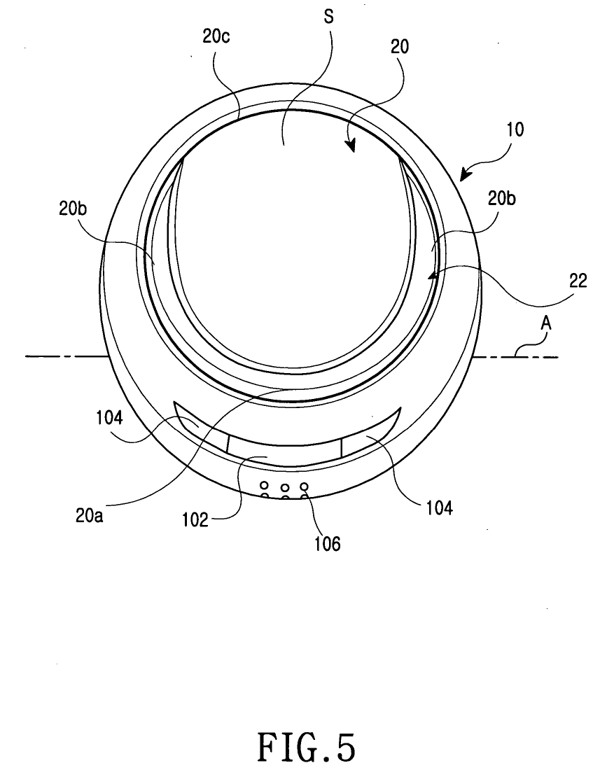

As illustrated in FIG. 3, the cradle includes a desk-top housing 10, a cradle housing 20 for rotatably mounted about a hinge axis A (shown in FIG. 5) on the desk-top housing 10, and an optical alignment system 30 mounted in the cradle housing 20 and emitting a beam on a screen (not shown) in a desired direction.

As illustrated in FIG. 5, the desk-top housing 10 includes a display unit 102, one or more keys 104 and one or more lamps 106, preferably three kinds of which are mounted on a front surface of the desk-top housing 10. The display unit 102 is formed by a known LCD module. The keys 104 are closely disposed to the display unit 102, and preferably mounted flush with the display unit 102. The lamps 106 are also disposed adjacent to the display unit 102, and preferably mounted at a position lower than the display unit 102.

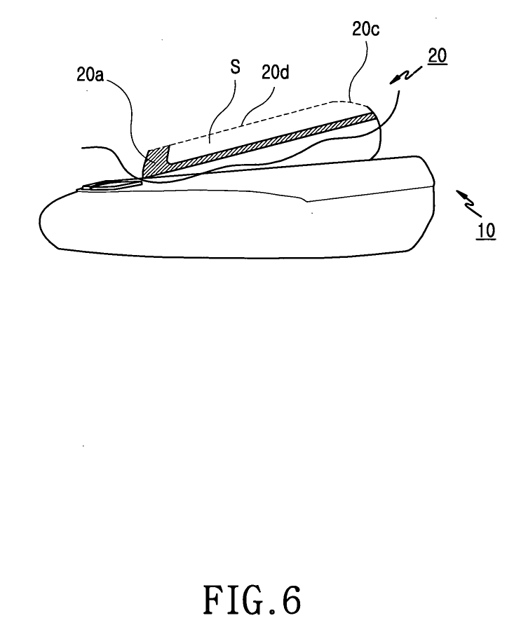

As illustrated in FIGS. 5 and 6, the cradle housing 20 is opened upward and rearward, but it is closed downward, forward and in both opposite lateral directions.

The cradle housing 20 has an upper portion 20d formed with a first opening, a front portion 20a and both lateral portions 20b, each of which is formed with a closed wall, and a rear portion 20e (shown in FIG. 3) formed with a second opening. The cradle housing 20 has a recess S taking a predetermined shape in order to cradle the portable terminal, wherein the recess S is surrounded by the closed walls 20a and 20b.

The closed walls, i.e., the front portion 20a and the both lateral portions 20b, are also indicated as a periphery 22 surrounding the front and both sides of the recess S. The periphery 22 restrains the state after the portable terminal is seated in the recess S of the cradle housing 20.

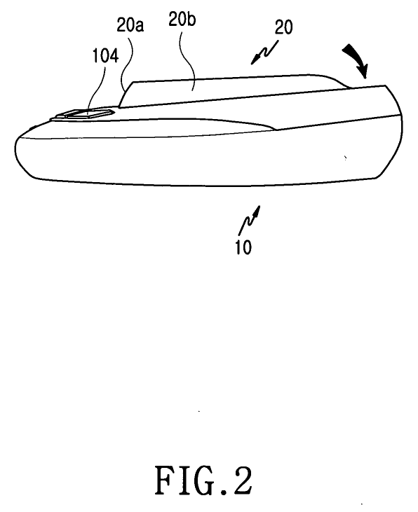

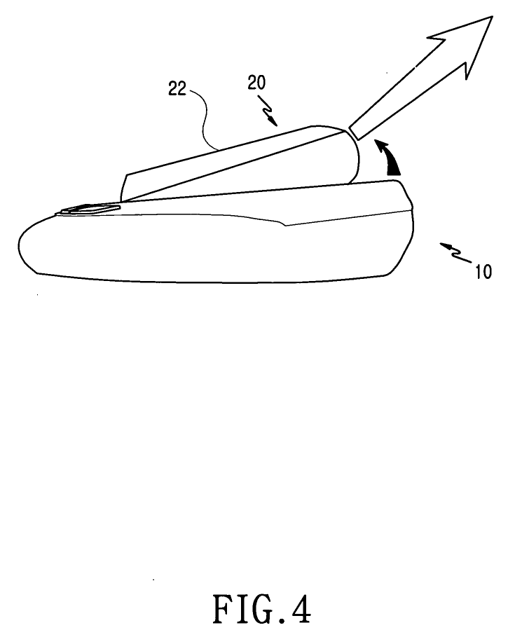

The cradle housing 20 is rotatably mounted about an hinge axis A (see FIG. 5), thus the rear portion 20e (shown in FIG. 3) pops in and out the desk-top housing 10. FIGS. 1 and 2 illustrate a state in that the rear portion 20e pops in the desk-top housing 10, while FIGS. 3 and 4 illustrate a state wherein the rear portion 20e pops out the desk-top housing 10. The hinge axis A of the cradle housing 20 runs across the cradle housing 20.

The rear portion 20e of cradle housing 20 is provided with the optical alignment system 30. The optical alignment system 30 includes an optical source and a lens system for guiding a beam emitted from the optical source, both of which are not shown in detail in the drawings. In the lens system, a lens is only shown in the drawings. The optical alignment system 30, preferably, includes a beam projector, more preferably a laser beam projector. In the state as in FIG. 1, the optical alignment system 30 is protected by popping in the desk-top housing 10. In the state as in FIG. 3, the optical alignment system 30 is exposed outside by popping out the desk-top housing 10. The desk-top housing 10 functions to protect the optical alignment system 30. The optical alignment system 30 is designed to pop in or out the desk-top housing 10 according to a rotational direction of the cradle housing 20. This is because the optical alignment system 30 is mounted on a lower side of the rear portion 20e of cradle housing 20.

FIG. 4 illustrates a direction in which a laser beam is emitted from the optical alignment system 30, as an arrow.

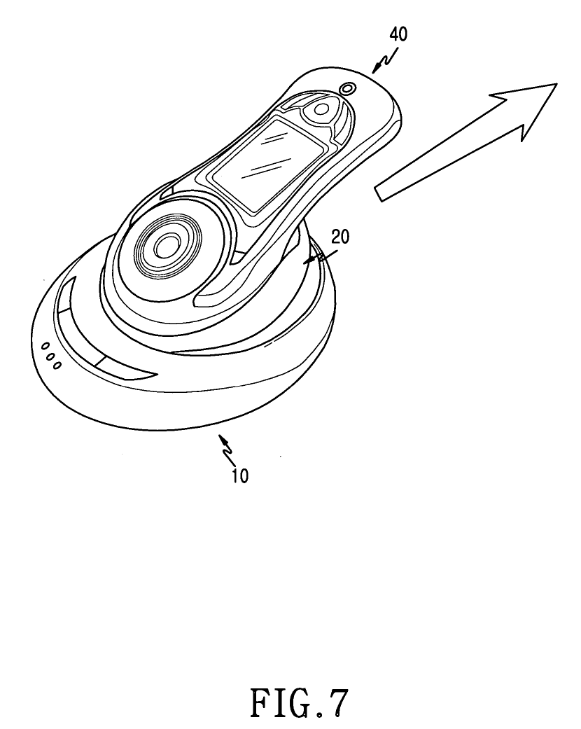

A plurality of data are transmitted between the cradle and the portable terminal using a preferred local area network, such as a Bluetooth™ based module. FIG. 7 illustrates that the portable terminal is cradled in a cradle according to the preferred embodiment of the present invention, and that the cradle housing 20 protrudes from a desk-top housing 10. As shown in FIG. 7, the beam emitted from the optical alignment system 30 is cast on a screen. Thus, the user of the portable terminal can see the data displayed on the screen. The transmitted data are displayed not only on a display panel of the display unit 102 of the portable terminal but also on a screen (not shown) having an increased surface area. Consequently, the user can additionally see the data displayed on the screen in an enlarged scale.

As described above, the present invention is designed so that the cradle housing is provided with a beam projector, that the cradle housing is rotatably mounted on a desk-top housing 10, and that data to be output from the portable terminal are displayed on a screen using the beam projector. As a result, the user of the portable terminal can see the data displayed on the screen.

While the invention has been shown and described with reference to certain preferred embodiments thereof, it will be understood by one skilled in the art that various modifications may be made therein without departing from the spirit and scope of the invention as defined by the appended claims.

1. A cradle for a portable terminal comprising:
a desk-top housing;
a cradle housing including an upper portion with a first opening, a rear portion with a second opening, and a front portion and a pair of lateral portions which form a closed wall, the cradle housing having a recess defined by the closed wall in order to cradle a portable terminal, the cradle housing being rotatably mounted about an hinge axis on the desk-top housing so that the rear portion pops in and out the desk-top housing; and
an optical alignment system mounted at a predetermined position of the cradle housing and emitting a beam in a predetermined direction.

2. The cradle for a portable terminal according to claim 1, wherein the optical alignment system further comprises a laser beam projector mounted on the rear portion of the cradle housing to emit the beam in a rearward direction.

3. The cradle for a portable terminal according to claim 1, wherein the desk-top housing further comprises a display unit, at least one key disposed adjacent to the display unit, and at least one lamp disposed adjacent to the key and the display unit, the display unit, the key and the lamp being mounted at a front portion of the desk-top housing.

4. The cradle for a portable terminal according to claim 1, wherein the cradle housing restrains movement of the cradled portable terminal by the closed wall of the front and both lateral portions.

5. The cradle for a portable terminal according to claim 1, wherein the optical alignment system is mounted on a lower side of the rear portion of the cradle housing.

6. The cradle for a portable terminal according to claim 1, wherein the optical alignment system pops in and out the desk-top housing according to a rotating direction of the cradle housing.
